(19) United States
(12) Patent Application Publication
(10) Pub. No.: US 2014/0308414 A1
(43) Pub. Date: Oct. 16, 2014

(54) BREWING CONTAINER AND LID

(71) Applicant: Laura Bougdanos, Espoo (FI)

(72) Inventor: Laura Bougdanos, Espoo (FI)

(21) Appl. No.: 14/300,449

(22) Filed: Jun. 10, 2014

Related U.S. Application Data
(63) Continuation-in-part of application No. 13/504,909, filed on Apr. 27, 2012.

(51) Int. Cl. A47J 31/18; A23F 3/18

(52) U.S. Cl. CPC A47J 31/18; A23F 3/18
USPC 426/425; 99/323

(57) ABSTRACT

The brewing container and lid of the present invention is used for drinking and controllably brewing a beverage. The brewing container and lid includes a container, a lid attachable to the container, and a brewing bag. The container has V-like shaped base, and an upper edge defining an opened end. The lid has an upper side, an opening defined through the upper side for drinking the beverage, and a cup extending away from the upper side. The cup is configured to receive the brewing bag allowing a liquid in the container too steep with a brewing material in the brewing bag. The V-like shaped base enables the container and the lid attached thereto to be placed in at least two separate standing positions being a brewing position when the container is standing on one of first and second angled sides, and a non-brewing position.

### CROSS-REFERENCE TO RELATED APPLICATION

This application is a continuation-in-part under 35 U.S.C. §120 based upon co-pending U.S. patent application Ser. No. 13/504,909, filed on Oct. 29, 2010. Additionally, this present application claims the benefit of priority of co-pending U.S. patent application Ser. No. 13/504,909, filed on Oct. 29, 2010. The entire disclosures of the prior application(s) is incorporated herein by reference.

### BACKGROUND OF THE INVENTION

1. Field of the Invention

The present invention relates to a brewing container and lid for use in connection with controllably brewing or steeping a beverage in a container. The container has a functional shape achieved with a V-like-shaped base, which enables the container to be placed in two separate standing positions one for brewing and another neutral or non-brewing position for drinking the brewed beverage.

2. Description of the Prior Art

The use of containers and lids that assist in brewing or steeping of a beverage are known in the prior art. However, these known devices have a disadvantage in that they are not able to control the steeping time as required by a user.

Tea or coffee is normally made by means of brewing bags or by pouring water through tea blades/leaves or keeping water in contact with the tea blades in different containers and, thereafter removing the container from a tea cup. Problems with the existing solutions are the need for the hassling removal of the brewing bag or the container from the tea before drinking, the unpractical filling and cleaning of the tea bags and containers and the difficulty of getting the right concentration of the tea. In addition, the containers containing the tea material are often not very tight, whereby tea material runs to the tea water.

While the above-described devices fulfill their respective, particular objectives and requirements, the aforementioned patents do not describe a brewing container and lid that allows controllably brewing and steeping a beverage in a container.

Therefore, a need exists for a new and improved brewing container and lid that can be used for controllably brewing and steeping a beverage in a container. In this regard, the present invention substantially fulfills this need. In this respect, the brewing container and lid according to the present invention substantially departs from the conventional concepts and designs of the prior art, and in doing so provide an apparatus primarily developed for the purpose of controllably brewing and steeping a beverage in a container.

### SUMMARY OF THE INVENTION

In view of the foregoing disadvantages inherent in the known types of brewing container and lid systems now present in the prior art, the present invention provides an improved brewing container and lid, and overcomes the above-mentioned disadvantages and drawbacks of the prior art. As such, the general purpose of the present invention, which will be described subsequently in greater detail, is to provide a new and improved brewing container and lid and method which has all the advantages of the prior art mentioned heretofore and many novel features that result in a brewing container and lid which is not anticipated, rendered obvious, suggested, or even implied by the prior art, either alone or in any combination thereof.

To attain this, the present invention essentially comprises a brewing container and lid for drinking and controllably brewing a beverage. The brewing container and lid includes a container, and a lid removably attachable to an upper edge of the container. The container has a base featuring a first angled side and a second angled side. The upper edge of the container defines an opened end opposite the base. The container is configured to receive a liquid. The lid has an upper side, an opening defined through the upper side, and a cup extending away from the upper side. The cup is configured to removably receive a brewing bag. The first and second angled sides of the base enable the container and the lid attached thereto to be placed in at least two separate standing positions being a brewing position when the container is standing on one of the first and second angled sides, and a non-brewing position.

The lid of the present invention may also include a pair of walls extending from the upper side toward each other, and a first ledge between the walls. The first ledge defines an open space thereabove and between the walls. The walls and the first ledge are located between the cup and the recessed base.

There has thus been outlined, rather broadly, the more important features of the invention in order that the detailed description thereof that follows may be better understood and in order that the present contribution to the art may be better appreciated.

The lid may also include a recessed base portion between the opening and the cup, with the recessed base configured to receive a portion of the brewing bag when in a stored and non-brewing position.

There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved brewing container and lid that has all of the advantages of the prior art brewing container and lid systems and none of the disadvantages.

It is another object of the present invention to provide a new and improved brewing container and lid that may be easily and efficiently manufactured and marketed.

An even further object of the present invention is to provide a new and improved brewing container and lid that has a low cost of manufacture with regard to both materials and labor, and which accordingly is then susceptible of low prices of sale to the consuming public, thereby making such brewing container and lid economically available to the buying public.

Still another object of the present invention is to provide a new brewing container and lid that provides in the apparatuses and methods of the prior art some of the advantages thereof, while simultaneously overcoming some of the disadvantages normally associated therewith.

Even still another object of the present invention is to provide a brewing container and lid for controllably brewing and steeping a beverage in a container. This allows the user the option to steep or not to steep the liquid and the option control the steeping time of the beverage by adjusting the tilt of the container.

Lastly, it is an object of the present invention to provide a new and improved method of using a brewing container and lid by filling a container with a liquid to a predetermined level. Then attaching a lid to an upper edge of the container. A brewing bag containing brewing material may then be inserted into a cup of the lid so that the brewing material is in an interior of the cup. The cup extends from an upper side of the lid toward the liquid when the lid is attached to the container. The user may then tilt the container so that an angled side of a base of the container rests on a surface. Then allowing the liquid to enter the cup so as to contact the brewing material of the brewing bag.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an embodiment of the brewing container and lid with an exploded brewing bag constructed in accordance with the principles of the present invention, with the phantom lines depicting environmental structure and forming no part of the claimed invention.

FIG. 2 is a top elevational view of the brewing container and lid of the present invention.

FIG. 3 is a cross-section view of the brewing container and lid taken along line 3 in FIG. 1.

FIG. 4 is an enlarged cross-sectional view of the brewing container and lid of FIG. 3.

FIG. 5 is a cross-section view of the base of the brewing container and lid taken along line 5 in FIG. 3.

FIG. 6 is a perspective view of the brewing bag of the present invention.

FIG. 7 is a perspective view of the brewing container and lid with the brewing bag in a stored position.

FIG. 8 is a perspective view of the brewing container and lid with the brewing bag in a brewing position.

FIG. 9 is a cross-section view of the brewing container and lid tilted in a non-brewing position.

FIG. 10 is a cross-section view of the brewing container and lid tilted in a brewing position.

The same reference numerals refer to the same parts throughout the various figures.

### DETAILED DESCRIPTION OF THE INVENTION

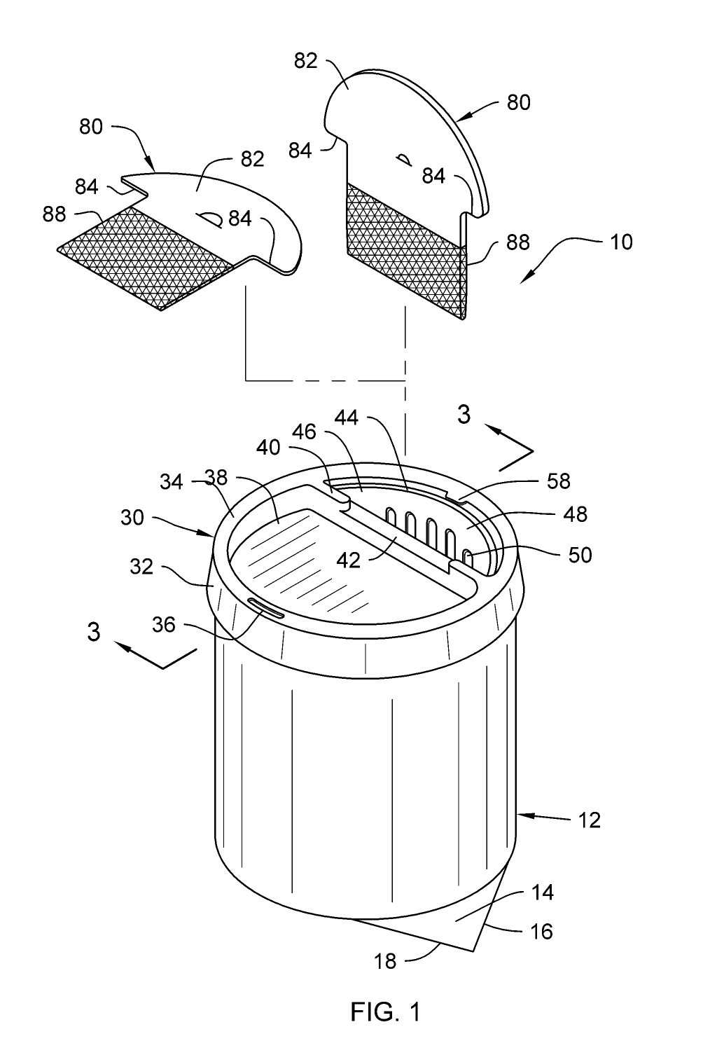

Referring now to the drawings, and particularly to FIGS. 1-10, an embodiment of the brewing container and lid of the present invention is shown and generally designated by the reference numeral 10.

In FIG. 1, a new and improved brewing container and lid 10 of the present invention for controllably brewing and steeping a beverage in a container is illustrated and will be described. More particularly, the brewing container and lid 10 has a container 12, a lid 30, and a brewing bag 80. The brewing container 12 is configured to be supported on a surface and grasped by a user to drink a liquid or beverage therein.

The container 12 has a base 14 featuring a first angled side 16 and a second angled side 18 configured so the angled sides converge while extending away from the container 12. The base 14 has a substantially V-like-shaped configuration. The container 12 has a substantially cylindrical shape and defines an opened end defined by an upper edge, and an interior volume configured to retain a liquid. The container 12 may further include an outer sleeve 20, which may be made of an insulating or cushioning material. It can be appreciated that the shape of the container can be any shape defining an opened end and interior volume. The lid 30 is configured to removable hold the brewing bag 80 in a stored position not in the interior volume of the container, and in a brewing position in the interior volume.

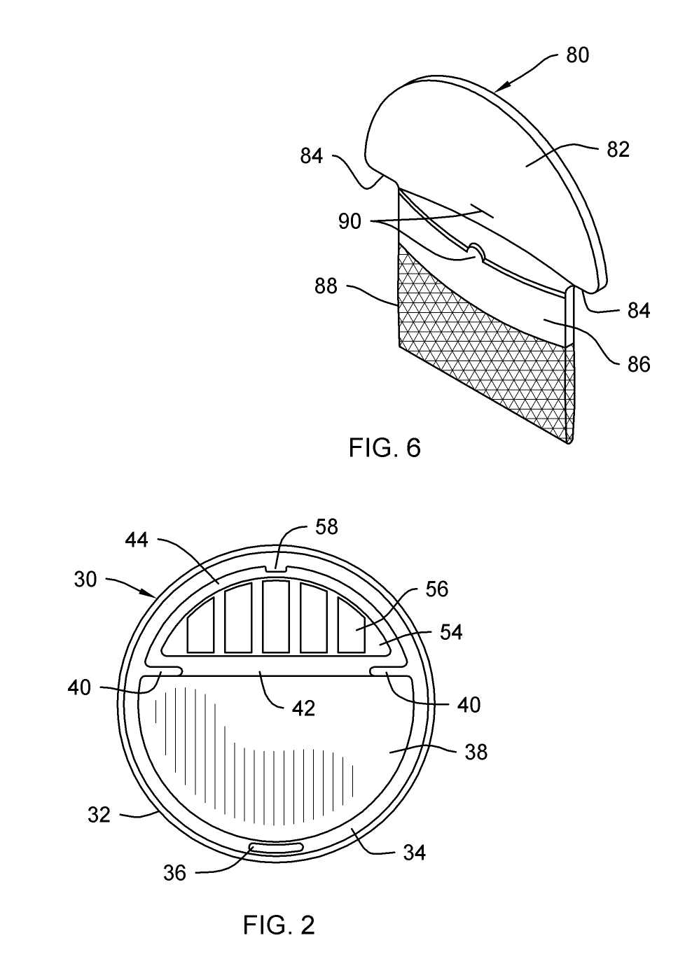

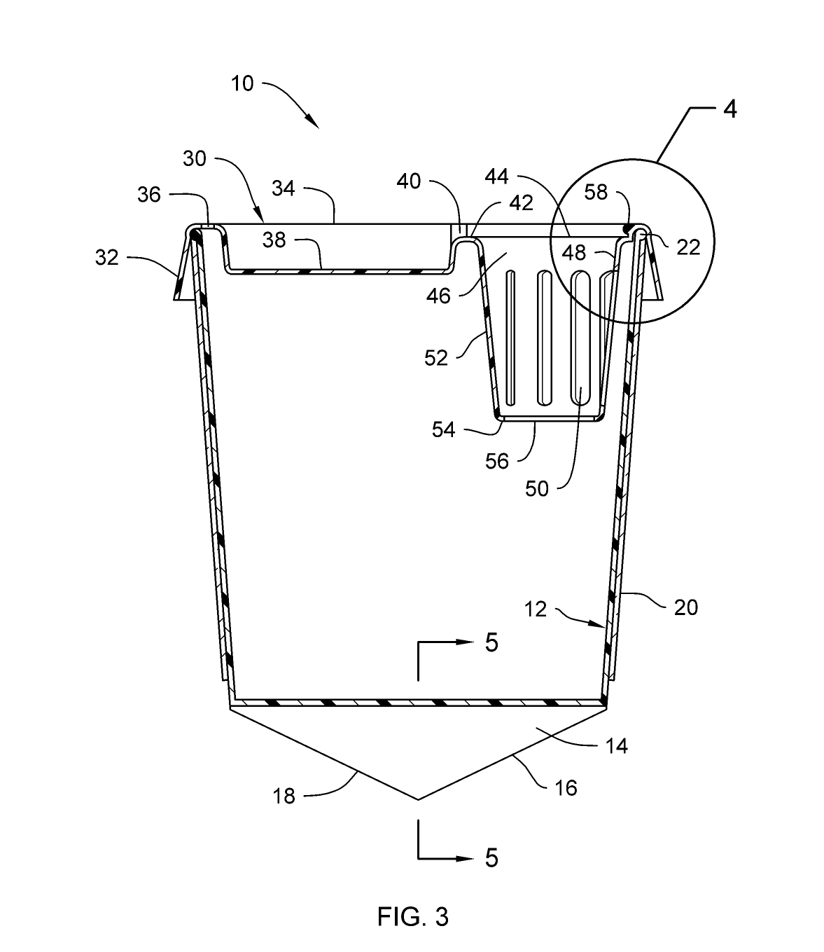

Referring now to FIGS. 2 and 3, the lid 30 includes an annular rim 32 extending away from a top side 34. The annular rim 32 may taper outwardly from the top side 34. An opening 36 is defined through the top side 34 which is in communication with the interior volume of the container 12 when the lid 30 is fitted to the container 12. The lid 30 is divided into a first section adjacent the opening 36, and a second section opposite the opening 36.

The first section has a recessed base 38 that is spaced and extending away from the top side 34. The recessed base 38 includes an edge that extends across a width of the lid 30. A pair of walls 40 extends toward each other from opposite sides of the top side 34, while creating a gap therebetween. The walls 40 extend down to the recessed base 38 to create the edge.

Between the walls 40 is a first ledge 42, with a height between the recessed base 38 and a top surface of the walls 40. Thus creating a wall extending up from the recessed base 38 a distance less than the walls 40. The first ledge 42 has a width larger than a width of the walls 40, thus extending the first ledge 42 past and adjacent to the walls 40 on one side thereof.

The second section of the lid 30 includes a cup 46 that extends away from a second ledge 44 into the interior volume of the container 12 when the lid 30 is fitted installed. The second ledge 44 is at the same height as the first ledge 42, thus creating a continuous ledge along a periphery of the second section which is recessed from the top side 42, as best illustrated in FIGS. 2 and 3.

The cup 46 includes a first wall 48, a second wall 52, and a base 54, and with the first and second walls being straight or tapering. The first wall 48 may have a shape that substantially corresponds with the annular rim 32, or may be arcuate in profile. A plurality of slots 50 are defined through the first wall 48 in a longitudinal directional thereof. The second wall 52 extends from the first ledge 42, and may connect between ends of the first wall 48. The base 54 defines a plurality of openings 56 therethrough, and extends down from the top side 34 a distance greater than the recessed base 38, as best illustrated in FIG. 3. It can be appreciated that slots 50 and openings 56 are in communication with the interior volume of the container 12 when installed, thereby allowing liquids and/or gases to pass therethrough.

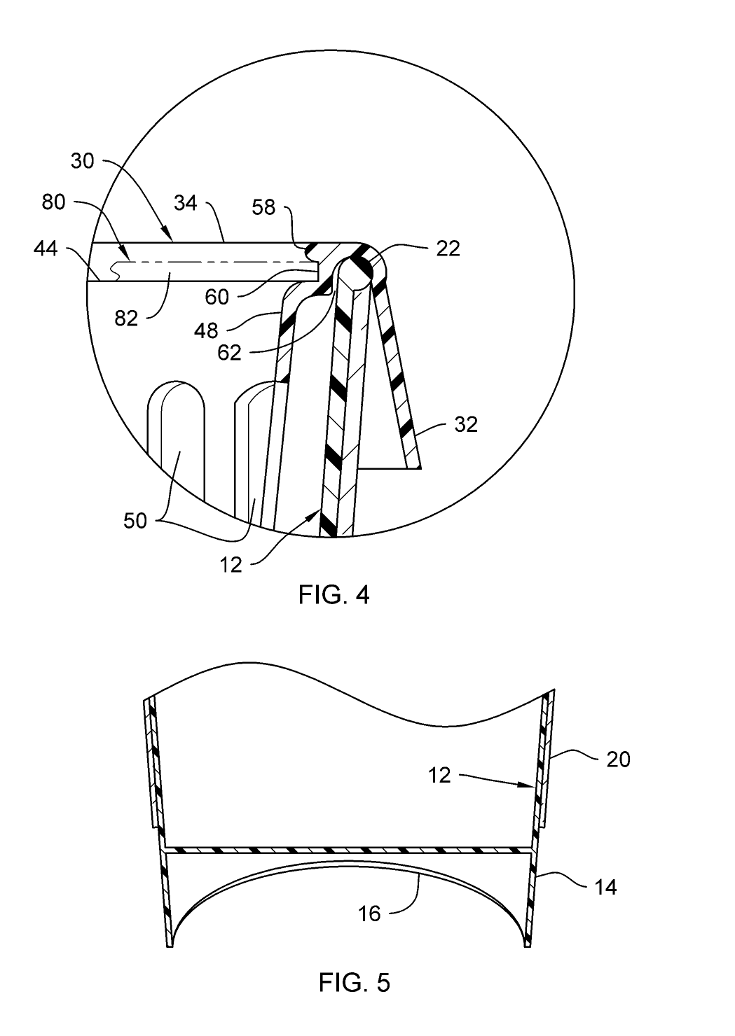

Referring to FIG. 4, the lid 30 additionally includes a projection 58 that extends from and parallel with the top side 34. The projection 58 creates a notch 60 between the projection 58 and the second ledge 44. The notch 60 is sized to receive a tag 82 of the brewing bag 80 when the brewing bag 80 is in the stored position. The lid 30 further includes an annular groove 62 defined interiorly and adjacent where the annular rim 32 and the top side 34 meet. The groove 62 is configured to securely and removable receive an upper edge 22 of the container 12 that defines the opened end. The groove 62 and upper edge 22 have corresponding profiles that allows them to interlock. The groove 62 is further configured to allow the upper edge 22 to be released therefrom when the groove 62 is enlarged due to flexing of the annular rim 32 away from the container 12.

The tapered configuration of the cup 46 creates a gap between the first wall 48 and the container 12, thus allow liquid and/or gases to pass through the slots 50 and into the interior of the cup 46.

The base 14, as best illustrated in FIG. 5, is made of a cylindrical sidewall that is cut at two angles to produce the first and second angled sides 16, 18. The interior of the base 14 may be hollow or by filled with a material, such as but not limited to an insulated material. It can be appreciated that the base 14 may be a separate element that is attachable to a bottom of the container 12, thereby converting a standard container or cup into a tiltable container.

Referring to FIG. 6, the brewing bag 80 includes the tag 82, and a meshed pouch 88. The tag 82 is made of a rigid material and includes a pair of edges 84, and a strip 86 that defines an opening. The edges 84 are adjacent to the ends of the strip 86 opposite each other. The strip 86 is flexibly connected to the tag 82 at its ends, and features a tab and slot 90 closing means. It can be appreciated that other closing means may be, but not limited to; snaps, adhesives, and mechanical fasteners can be used instead of the tab and slot 90.

The meshed pouch 88 has an opened end connected to the tag 82 and strip 86, so that an interior of the meshed pouch 88 is in communication with the opening. The meshed pouch 88 is configured to receive and retain therein a brewing material, such as but not limited to, tea leaves.

It can be appreciated that the container is designed so as to be orientated upwardly when held or walked with by the user, and additionally so that it can by tilted in either the brewing or non-brewing position when placed on a surface or held by the user. Thus allowing the user to keep the brewing bag in place, and not continuing to steep while walking or holding the container upright. This may be provided by the design of the container or with a collar surrounding the container.

It can also be appreciated that data device may be incorporated with the container 12 or lid 30, whether disposable or not. The data device may be, but not limited to, a barcode, optical code, label, radio frequency identification (RFID) or transceiver chip. The user could scan the data device via a portable electronic device, and then which may: serve as a payment method, signal the user of the temperature, provide the user with steeping time, temperature, health benefits, geography info of where the tea was grown, savings coupons, store loyalty points and bonus offers, etc. through an app or a database on a web site. This type of interaction may be very useful and further build the brand image in tying into virtual, social, digital media with every day common things like drinking tea etc.

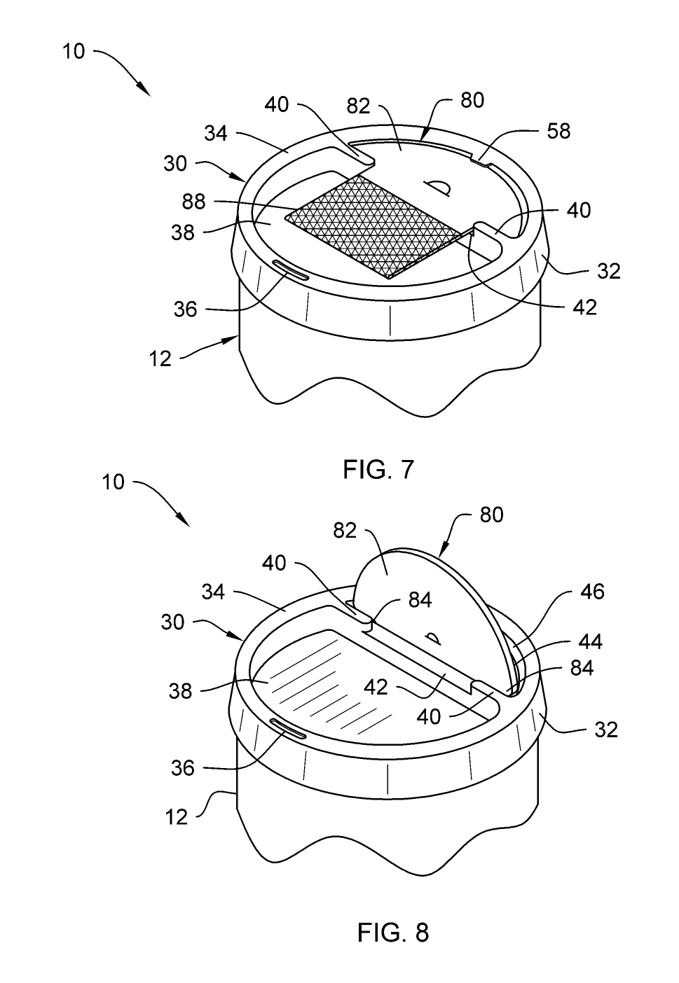

In the bag stored position, as best illustrated in FIG. 7, it can now be understood that the brewing bag 80 is not located in the cup 46, but may be retained in the upper interior of the lid 30. The tag 82 is positioned in the second section so that an edge of the tag 82 is received in the notch 60, and retained therein by the projection 58. In this stored position, the edges 84 of the tag 82 abut or are adjacent to a side of the walls 40 in communication with the second section. An end portion of the tag 82 or the strip 86 is consequently supported by the first ledge 42, while a perimeter of the tag 82 is supported by the second ledge 44. The meshed pouch 88 is accordingly located in the first section above the recessed base 38. In this stored position, the brewing bag 80 can be kept out of the cup 46 until a beverage is ready to be brewed.

In the brewing position, as best illustrated in FIG. 8, it can now be understood that the brewing bag 80 is located in the cup 46. The user would insert the brewing bag 80 into the cup 46 so that the meshed pouched is interior of the cup 46, and the tag 82 is exterior of the cup 46. The edges 84 of the brewing bag 80 abut and are supported by the second ledge 44 so as to keep the meshed pouched inside the cup 46. Notches or ridges (not shown) associated with the second ledge 44 may be used to secure the tag 82 in position on the second ledge 44.

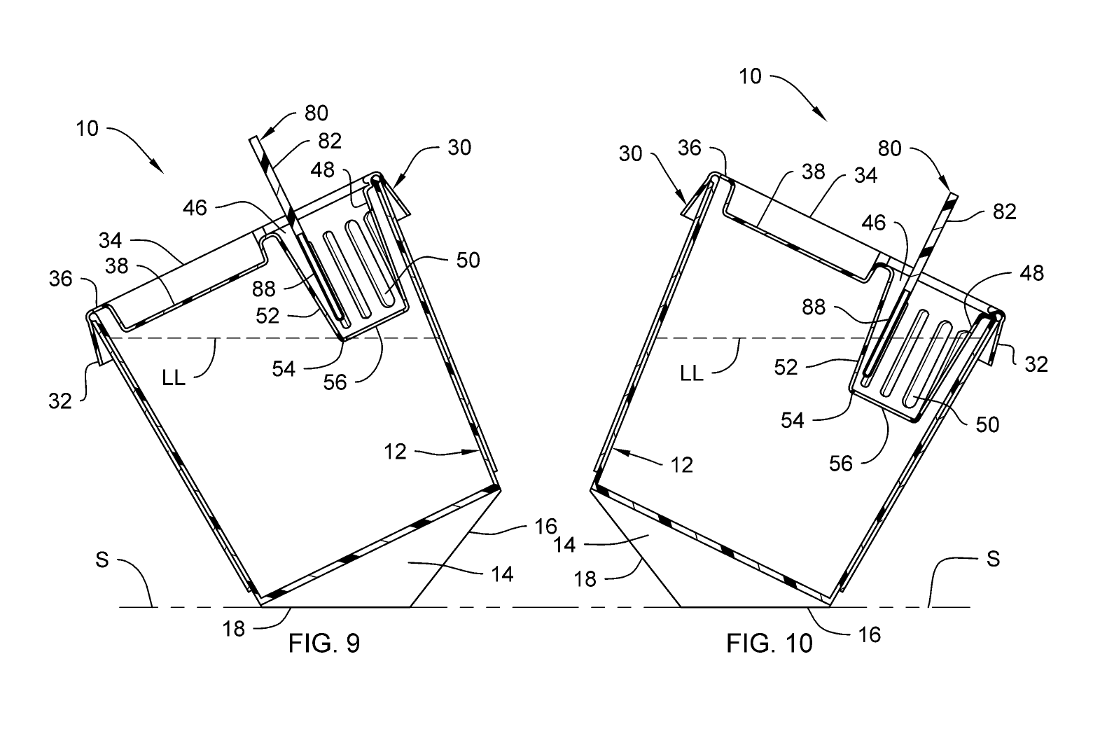

In use it can be understood that an example of the non-brewing position of the container 12 is illustrated in FIG. 9. The user could fill the container 12 with a liquid to a predetermined liquid level LL, and rest the container 12 on a surface S. The user could tilt the container 12 so that it rest on the second angled side 18 of the base 14. This would tilt or angle the container 12 in relation to the surface S so that the cup 46 is above the liquid level LL, thereby not immersing the brewing bag 80 in the liquid. The non-brewing position prevents the liquid from entering the cup 46 and thus prevents the liquid from being brewed or steeped.

To brew or steep the liquid, the user could tilt the container 12 so that the first angled side 16 of the base 14 rests on the surface S. This would tilt the container 12 so that a lower portion of the first wall 48 and the second wall 52, and the base 54 of the cup 46 are below the liquid level LL. Consequently, the brewing bag 80 in the brewing position would have its meshed pouch 88 immersed in the liquid. The liquid in the container 12 would now be allowed to travel into the cup 46 via the slots 50 of the first wall 48 and the openings 56 of the base 54. The liquid in the cup 46 would begin to brew or steep with the brewing material in the meshed pouch 88. After a predetermined time, the use may stop the brewing or steeping of the liquid by tilting the container 12 back to the non-brewing position or to an upright position. The amount of steeping time and brewed concentration is controlled by the user simply by the amount of tilt the container 12 is at.

While embodiments of the brewing container and lid have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as metal, plastic, cardboard, or a variety of wood may be used instead of the above-described. And although controllably brewing and steeping a beverage in a container have been described, it should be appreciated that the brewing container and lid herein described is also suitable for dissolving any material with a liquid stored in a container having a lid and a V-shaped base.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A brewing container and lid for drinking and controllably brewing a beverage, said brewing container and lid comprising:
a container having a base featuring a first angled side and a second angled side, and an upper edge defining an opened end opposite said base, said container being configured to receive a liquid; and
a lid removably attachable to an upper edge of said container, said lid having an upper side, an opening defined through said upper side, and a cup extending away from said upper side, said cup being configured to removably receive a brewing bag;
wherein said first and second angled sides of said base enabling said container and said lid attached thereto to be placed in at least two separate standing positions being a brewing position when said container is standing on one of said first and second angled sides, and a non-brewing position.

2. The brewing container and lid according to claim 1, wherein said lid further comprising a recessed base portion between said opening and said cup.

3. The brewing container and lid according to claim 1, wherein said lid further comprising a pair of walls extending from said upper side toward each other, and a first ledge between said walls, said first ledge defining an open space thereabove and between said walls, said walls and said first ledge being located between said cup and said recessed base.

4. The brewing container and lid according to claim 3, wherein said cup further comprising a second ledge on a same plane as said first ledge.

5. The brewing container and lid according to claim 4, wherein said cup of said lid further comprising a first wall defining at least one slot, a second wall, and a cup base defining at least opening.

6. The brewing container and lid according to claim 5, wherein said first wall extending away from said second ledge, and said second wall extending from said first ledge.

7. The brewing container and lid according to claim 5, wherein at least a portion of said slot and said opening of said cup are immersed in the liquid when said container is said brewing position.

8. The brewing container and lid according to claim 5, wherein said first wall is arcuate, and said second wall is planar.

9. The brewing container and lid according to claim 4, wherein said second ledge is configured to support at least one portion of a first section of said brewing bag so that a second section of said brewing bag is received in said cup.

10. The brewing container and lid according to claim 9, wherein said lid further comprising a projection extending from said upper side in a spaced relation from said second ledge to define a notch between said projection and said second ledge.

11. The brewing container and lid according to claim 10, wherein said notch is configured to receive a second portion of said first section of said brewing bag therein to secure said brewing bag in a stored position, while said second section of said brewing bag is adjacent said recessed base of said lid orienting said brewing bag in the stored position.

12. The brewing container and lid according to claim 11, wherein in the stored position said second ledge supports a perimeter of said first section of said brewing bag.

13. A method of using a brewing container and lid, said method comprising the steps of:
a) filling a container with a liquid to a predetermined level;
b) attaching a lid to an upper edge of said container;
c) inserting a brewing bag containing brewing material into a cup of said lid so that the brewing material is in an interior of said cup, wherein said cup extends from an upper side of said lid toward the liquid when said lid is attached to said container;
d) tilting said container so that an angled side of a base of said container rests on a surface; and
e) allowing the liquid to enter said cup so as to contact the brewing material of said brewing bag.

14. The method according to claim 13 further comprising the step of tilting said container in a direction opposite to that of step d) to remove the brewing material from the liquid.

15. The method according to claim 13, wherein said lid further comprising a first ledge and ledge on a second ledge on a same plane as said first ledge, said second ledge is configured to support at least one portion of a first section of said brewing bag so that a second section of said brewing bag containing the brewing material is received in said cup.
